(19) United States
(12) Patent Application Publication
(10) Pub. No.: US 2020/0204355 A1
(43) Pub. Date: Jun. 25, 2020

(54) METHOD AND DEVICE FOR TRANSMITTING PERSONAL DATA

(71) Applicant: Robert Bosch GmbH, Stuttgart (DE)

(72) Inventors: Johanna Konrad-Mausser, Asperg (DE); Jamshid Shokrollahi, Ludwigsburg (DE); Nik Scharmann, Bietigheim-Bissingen (DE)

(21) Appl. No.: 16/629,219

(22) PCT Filed: Jul. 5, 2018
(86) PCT No.: PCT/EP2018/068238

§ 371 Date: Jan. 7, 2020

(30) Foreign Application Priority Data
Jul. 12, 2017 (DE) 10 2017 211912.8

(51) Int. Cl. H04L 9/08; G06Q 20/38; G06Q 20/40

(52) U.S. Cl. CPC H04L 9/085; H04L 9/0861; H04L 9/0825; H04L 2209/805; G06Q 20/407; H04L 2209/56; G06Q 2220/00; G06Q 20/3829

(57) ABSTRACT

The invention relates to a method for transmitting personal data. The method includes a step of receiving a request (130) of a sensor unit (120) by a group (102) of monitoring units (104, 106, 18, 110), a step of generating an encryption key and shares (134, 136, 138, 140) of a decryption key by the group (102) of monitoring units (104, 106, 108, 110), a step of providing the encryption key (132) to the sensor unit (120) via the sensor interface (112), and a step of providing the shares (134, 136, 138, 140) of the decryption key to an end unit (122).

### BACKGROUND INFORMATION

The present invention is directed to a device or a method according to the definition of the species in the independent claims. The subject matter of the present invention is also a computer program.

Private data evolve to become important capital for the user. Hence, there is intense competition between different service providers and manufacturers to obtain access to these data. The data may be used to improve the quality of the services offered and to predict different market trends or consumer trends. It is therefore natural for the user to expect money for these resources.

### SUMMARY OF THE INVENTION

Against this background, a method for transmitting personal data, furthermore, a device that uses this method, and finally a corresponding computer program according to the main claims is presented with the approach presented herein. Advantageous refinements of and improvements on the device specified in the independent claim are possible with the measures cited in the dependent claims.

With the approach described herein, it is advantageously possible not only to transmit personal data generated by a user, but to also transmit data that are measured by sensors. The transmission of such data may effect a financial benefit for the owner of these sensors. In this case, it may be advantageously ensured for the buyer of these data that the data from the data seller are not sold to more than one buyer. By developing a suitable countermeasure for such a threat, the buyers may avoid losing their advantages over their competitors. This is similar to the double spending of digital money, which is addressed by the bitcoin protocol. In the problem of the double spending, the buyer must be assured that the money received has not already been spent by the party that paid it. In the case of digital money, it becomes apparent at some time that a coin involved in a transaction has already been used. As a result, the receiver of the coin is motivated to refuse such a transaction.

The approach presented here is therefore similar to so-called “sticky policy” solutions for protecting the privacy of data. Such solutions are based on guidelines, which are specified in order to enable a receiver to open an encrypted data packet. The fulfillment of these guidelines is verified by a secure hardware, which stores the encryption key for the data packet and releases the key only if the corresponding guidelines are fulfilled. In this case, it should be noted that the security of this method is based on the trust in the only secure hardware that stores the decryption key. If this part of the system malfunctions or cooperates with the buyer, the entire system collapses. The approach presented herein is similar to the “sticky policy” solutions, but is based on the security of multiple parts at the same time, so that the buyer would have to collaborate with multiple parties in order to be able to deceive. It is assumed that there is no direct channel between the buyer and the seller, otherwise the security of the system could fail.

One method for transmitting personal data includes the following steps:

receiving a request of a sensor unit represented by an electrical signal for detecting personal data via a sensor interface of a group of monitoring units to the sensor unit;

generating an encryption key as well as shares of a decryption key using the group of monitoring units, responding to the receipt of the request, the decryption key being divided into the shares using a method for secret sharing and each of the group monitoring units being assigned one of the shares;

providing the decryption key to the sensor unit via the sensor interface; and

providing the shares of the decryption key to an end unit via an end interface of the group of monitoring units to the end unit.

The sensor unit may be a known sensor, which may be carried by a user, for example. A sensor may, for example, be a temperature sensor, a pulse meter or a camera. An electrical signal may be a message signal. The sensor may be designed, for example, to detect data about an activity, a bodily function or the surroundings of the user as personal data. The sensor interface may be understood to mean an analog or digital interface of a device. The sensor interface may be wireless or hard-wired. The group of monitoring units may include at least two, three or more monitoring units. The monitoring units may be designed as electrical devices designed separately from one another. An electrical device may be a computer. The monitoring units are also referred to as monitors. The shares of the decryption key must represent different parts on the basis of which the decryption key may be composed. The monitoring units may, for example, be connected to one another via electrical lines or wirelessly in order to be able to organize the division of the decryption key among them. A method for secret sharing may be understood to mean a so-called “secure secret sharing.” Using multiple monitoring units may prevent the decryption key from being ascertained as a result of a monitoring unit being compromised. An end unit may be understood to mean an electrical device. An electrical device may be a computer. The end unit may also be referred to as a purchasing device for the first time purchasing of the personal data via the end interface, also referred to as a buyer interface. The purchasing device may also simply be referred to as buyer. The method is able to ensure that the personal data cannot be sold multiple times. In the event the sensor unit attempts to sell the data to another buyer, the monitoring units will block this transaction. As long as a few of the monitoring units—the number in this case is a function of the threshold method—are compromised, all non-compromised monitoring units will refuse to pass on their shares of the decryption key to the additional buyer.

The shares may be generated in the step of generating with the aid of any arbitrary “secure secret sharing” method. A “secure secret sharing” method distributes a secret in the shares so that that secret may be reconstructed only with access to all shares. In the general “threshold secure secret sharing” method, the secret is divided into n shares, so that the secret is reconstructable with the access to each subset having k<n elements.

One example of the “threshold secure secret sharing” method is the “Shamir method.” In this method, a degree k−1 polynomial is selected so that the constant value is the same as the secret, but all other coefficients are randomly selected. This means f(x)=rₖ₋₁x^{k-1}+rₖ₋₂x^{k-2}+ . . . rᵢx+p, all r coefficients being randomly selected and p being the secret.

In the division, n different values, for example, all numbers from 1 to n, are selected. Each share is made up of the value i and the evaluation of the polynomial f(x) at the position i. This means Sᵢ=(i, f(i)).

With the knowledge of the k shares, it is possible to calculate the coefficients of the polynomial using, for example, Lagrange interpolation and to thus arrive at the secret.

The provision takes place by the share (i, f(i) being sent to monitor i. The buyer in turn asks the monitor to send the share to it.

The buyer is to receive at least k shares in order to reconstruct the secret or the decryption key and to access the data. The method will achieve its security as long as at least k monitors accomplish their task correctly and do not pass their share onto the buyer if they recognize that the data were previously passed on or another condition is not fulfilled, for example, if the monitors suspect that the buyer will exploit the data.

In this way, it may be avoided, for example, that an individual monitor is compromised and resells the data.

Thus, the method may include a step of blocking the provision of the shares of the decryption key to the end unit, if the personal data have already been sold to another end unit. The blocking may ensure that after an initial sale, the data cannot be sold once again. To recognize whether the personal data have already been sold, the personal data may be provided with a clear indicator, which may be used by the end unit on the one hand to retrieve the personal data and on the other hand to retrieve the shares of the decryption key. In this way, the monitoring units are able to check using the indicator whether the instantaneous sale of the personal data is permissible and enable or block the provision of the shares of the decryption key regardless of a result of the check.

The method may include a step of generating encrypted personal data via the sensor unit. This may take place using the personal data and the encryption key. In this way, the data are able to be encrypted using the key known to the monitoring units.

In a step of receiving, the encrypted personal data may be received in the form of electrical signals via an input interface of a data board unit to the sensor unit. The data board device may be implemented as one or as a composite of multiple electrical devices. The data board unit may, for example, be a computer. The data board unit may be designed to pass through or to buffer the encrypted personal data. In a step of providing, the encrypted personal data are able to be provided via an output interface of the data board device to the end unit. With the data board unit, it is possible to avoid a direct contact between the sensor unit and the end unit.

In a step of decrypting, the encrypted personal data are able to be decrypted by the end unit using the shares of the decryption key. In this way, the end unit is able to access the personal data.

In a step of outputting, a payment instruction, for example, in the form of an electrical signal, may be output by the end unit. In this way, the personal data are able to be paid by the end unit.

In a step of receiving, the payment instruction, for example, in the form of an electrical signal, may be received by a transaction unit via an interface of the transaction unit to the end unit. The transaction unit may, for example, be designed to check the payment instruction and to generate a credit note for an owner of the sensor unit corresponding to the payment instruction. The payment device may be an electrical device, for example, a computer.

This method may, for example, be implemented in a distributed manner in software or hardware or in a mixed form of software and hardware, in one device or distributed among multiple devices.

The approach presented herein also provides a device, which is designed to carry out, activate or implement the steps of a variant of a method provided herein in corresponding units. With this embodiment variant of the present invention in the form of a device as well, it is possible to quickly and efficiently achieve the object underlying the present invention.

For this purpose, the device may include at least one processing unit for processing signals or data, at least one memory unit for storing signals or data, at least one interface to a sensor or to an actuator for reading in sensor signals from the sensor or for outputting data signals or control signals to the actuator and/or to at least one communication interface for reading in or outputting data, which are embedded in a communication protocol. The processing unit may, for example, be a signal processor, a microcontroller or the like, the memory unit capable of being a flash memory, an EEPROM or a magnetic memory unit. The communication interface may be designed to read in or output data in a wireless and/or hard-wired manner, a communication interface being able to read in or output the hard-wired data, to read in these data, for example, electrically or optically from a corresponding data transmission line or to output these data into a corresponding data transmission line.

A device may be understood in the present case to mean at least one electrical device, which processes electrical signals and outputs control signals and/or data signals as a function thereof. The device may include an interface, which may be designed in hardware and/or in software. In a hardware design, the interfaces may, for example, be part of a so-called ASIC system, which contains a variety of functions of the device. It is also possible, however, that the interfaces are dedicated, integrated circuits or are made up at least partially of discrete components. In a software design, the interfaces may be software modules, which are present, for example, on a microcontroller in addition to other software modules.

Also advantageous is a computer program product or computer program having program code, which may be stored on a machine-readable carrier or memory medium such as a semiconductor memory, a hard disk memory or an optical memory, and is used to carry out, implement and/or activate the steps of the method according to one of the previously described specific embodiments, in particular, if the program product or program is executed on a computer or on a device.

Exemplary embodiments of the approach presented herein are depicted in the drawings and explained in greater detail in the following description.

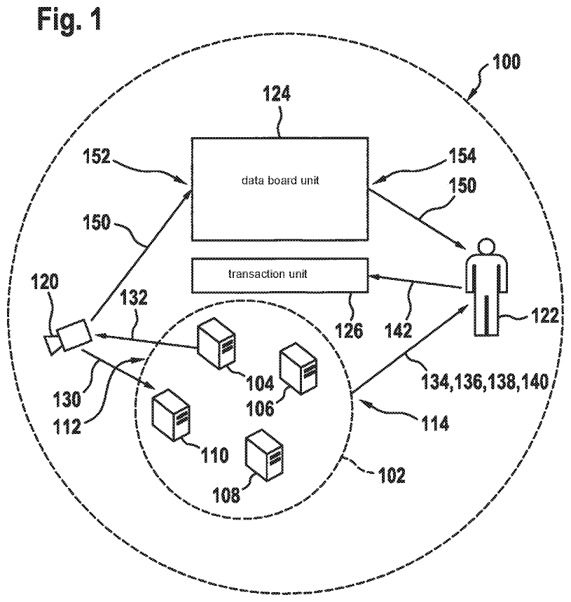

FIG. 1 shows a representation of a device for transmitting personal data according to one exemplary embodiment; and

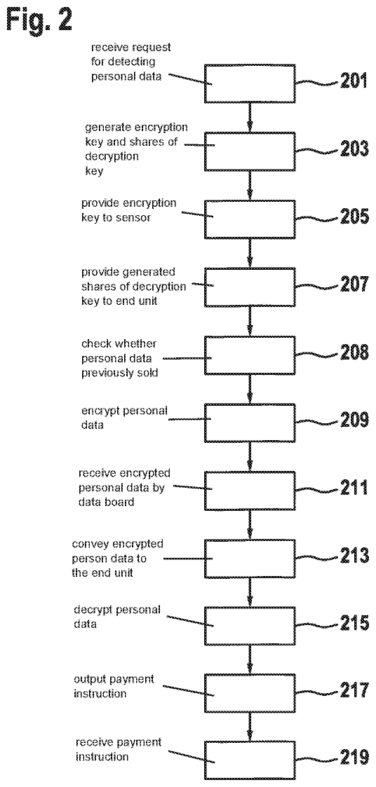

FIG. 2 shows a flow chart of a method for transmitting personal data according to one exemplary embodiment.

FIG. 1 shows a representation of a device 100 for transmitting personal data according to one exemplary embodiment. Device 100 includes at least one group 102 of monitoring units 104, 106, 108, 110, here, for example, of four monitoring units 104, 106, 108, 110, also referred to as monitors. Group 102 includes a sensor interface 112 and an end interface 114.

According to one exemplary embodiment, device 100 is designed as a system which, in addition to group 102, further includes at least one sensor unit 120, at least one end unit 122 as well as one data board unit 124 and a transaction unit 126 or further at least one of the aforementioned units 120, 122, 124, 126.

Sensor unit 120 is designed to detect personal data of a user. For example, sensor unit 120 may be integrated into an armband wearable by the user. Sensor unit 120 is designed to emit a request 130 to group 102. Group 102 is designed to receive request 130 via sensor interface 112. In response to the receipt of request 130, the group is designed to generate an encryption key 132 and shares 134, 136, 138, 140 of a decryption key. Encryption key 132 may be generated using one or multiple of monitoring units 104, 106, 108, 110. Shares 134, 136, 138, 140 of the decryption key may be generated using one or multiple of monitoring units 104, 106, 108, 110. In addition, shares 134, 136, 138, 140 may be stored by one or by multiple of monitoring units 104, 106, 108, 110. For example, a different share 134, 136, 138, 140 of the decryption key is stored in each of monitoring units 104, 106, 108, 110. Group 102 is designed to provide generated encryption key 132 via sensor interface 112 to sensor unit 120. Group 102 is further designed to emit shares 134, 136, 138, 140 of the decryption key via end interface 114 to end unit 122. Monitoring units 104, 106, 108, 110 may be locally separated from one another, for example, in different buildings, or situated adjacent to one another. According to one exemplary embodiment, each of monitoring units 104, 106, 108, 110 is designed as a server. Monitoring units 104, 106, 108, 110 according to one exemplary embodiment are connected to one another via a data transmission network.

End unit 122, for example, in the form of an electrical device assigned to a person, is designed to purchase the personal data detected by sensor unit 120. According to one exemplary embodiment, end unit 122 receives shares 134, 136, 138, 140 of the decryption key only after end unit 122 has transmitted a payment instruction 142 to transaction unit 126. For this purpose, monitoring units 104, 106, 108, 110 are designed according to one exemplary embodiment to check payment instruction 142 and to provide shares 134, 136, 138 to end unit 122 only after a positive result of the check of payment instruction 142.

Sensor unit 120 is designed to encrypt the detected personal data after receipt of encryption key 132 using encryption key 132, in order to obtain encrypted personal data 150. Sensor unit 120 is designed to send encrypted personal data 150 to data board unit 124. Data board unit 124 is designed to receive encrypted personal data 150 via an input interface 152 and according to one exemplary embodiment to buffer and/or transmit the encrypted personal data to end unit 122.

According to one exemplary embodiment, end unit 122 is designed to read out encrypted personal data 150 from data board unit 124 via an output interface 154.

End unit 122 is designed to decrypt encrypted personal data 150 in order to recapture the original personal data. End unit 122 in this case is designed to decrypt encrypted personal data 150 using shares 134, 136, 138, 140 of the decryption key received by group 102.

Individual or all of interfaces 112, 114, 152, 154 between units 102, 120, 122, 124, 126 may be designed as wireless data transmission interfaces. Alternatively, individual or all of interfaces 112, 114, 152, 154 between units 102, 120, 122, 124, 126 may be designed as hard-wired data transmission interfaces.

Exemplary embodiments of the method are described in greater detail below with reference to FIG. 1.

The method is based on threshold value encryption schemes of public keys, so-called “threshold public key encryption schemes.” Such a scheme is made up of a public encryption key 132, which may be used to encrypt data, and of n individual decryption keys 134, 136, 138, 140, also referred to previously as shares 134, 136, 138, 140 of a decryption key, so that at least k(k<=n) of decryption keys 134, 136, 138, 140 are necessary to decrypt key 132 or data 150 encrypted with key 132. For this purpose, FIG. 1 shows the general overview of the method according to one exemplary embodiment. First is the request of decryption key 132, depicted in FIG. 1 by the request 130. Second is the sending of encryption key 132 to sensor unit 120. Third is the writing of encrypted data 150 into data board unit 124. Fourth is the payment, depicted by way of example in FIG. 1 by payment instruction 142. Fifth is the receiving of shares 134, 136, 138, 140 of the decryption key. End unit 122 in this case receives shares 134, 136, 138, 140. Sixth is the reading of data 150 and the decryption of same by end unit 122.

According to one exemplary embodiment, monitors 104, 106, 108, 110 together monitor system 100 in order to protect the market against fraud.

For this purpose, sensor 120 intending to sell data first requests of monitors 104, 106, 108, 110 that monitors 104, 106, 108, 110 together generate public key 132 and shares 134, 136, 138, 140 of the decryption key, and to store these locally with themselves.

Secondly, monitors 104, 106, 108, 110 together generate a public, private key pair, send public key 132 to the sensor or sensors 120 and store shares 134, 136, 138, 140 locally.

Thirdly, sensor 120 encrypts the data and writes the encrypted value, referred to in FIG. 1 as encrypted personal data 150, on data board 124.

Fourthly, buyer 122 requests the data and pays for it.

Fifthly, monitors 104, 106, 108, 110 check that payment 142 is in order and that the transaction does not violate market principles. If correct, they send sufficient shares 134, 136, 138, 140 to buyer 122, who reads and encrypts data 150. In the event sensor 120 attempts to sell the same data to another buyer, monitors 104, 106, 108, 110 will block this transaction. As long as a few (number is a function of threshold methods) monitors 104, 106, 108, 110 are compromised, all non-compromised monitors will refuse to pass on their shares 134, 136, 138, 140 of the decryption key to the additional buyer. Suitable methods may be used to recognize that data 150 have already been sold once. For example, data 150 may be provided with a clear indicator for this purpose, which enables buyer 122 on the one hand to retrieve data 150 from data board 124 and also enables the buyer to retrieve the shares from monitors 104, 106, 108, 110 required for decryption. By checking the indicator, monitors 104, 106, 108, 110 are able to establish whether data 150 are being retrieved for the first time.

In order to sell the data in data board 124, each record, i.e., for example, each data entry, is provided with an indicator according to one exemplary embodiment. Thus, all data 150 buffered in data board 124 may be provided with a clear indicator.

The indicator may be an index or the result of a hash function, for example, regarding respective data 150. As a result, buyer 122 will be able to download data 150 from data board 124 and to subsequently ask monitors 104, 106, 108, 110 for the decryption key. As a result, monitors 104, 106, 108, 110 will recognize this attempt. Thus, it is important according to one exemplary embodiment that buyer 122 and the seller do not come into direct contact.

FIG. 2 shows a flow chart of a method for transmitting personal data according to one exemplary embodiment. The steps of the method may be carried out by units of the device described with reference to FIG. 1.

In a step 201, a request of a sensor unit for detecting personal data is received via a sensor interface of a group of monitoring units to the sensor unit. In response to the receipt of the request, an encryption key and shares of a decryption key are generated by the monitoring units in a step 203. The generated encryption key is provided to the sensor unit in a step 205. The generated shares of the decryption key are also provided to an end unit in a step 207. In this case, the shares are provided only if the personal data are being sold for the first time. If it is established using the monitoring units that the personal data have already been sold or are to be sold multiple times, then step 207 of the provision is blocked by a step 208. To be able to check whether the personal data had already been sold, the encrypted personal data stored in the data board unit may be provided with an indicator, which enables the end unit to download the encrypted personal data from the data board unit. The indicator may also be utilized by the end unit to submit a request to the monitoring units to provide the shares of the decryption key. Thus, the monitoring units according to one exemplary embodiment are designed to use the indicator provided by the end unit in step 208 to check whether the personal data have already been previously sold to a buyer. If the monitoring units establish that the personal data have already been sold, then the monitoring units are designed to block the provision of the shares.

According to one exemplary embodiment, the personal data are encrypted by the sensor unit in a step 209 using the encryption key to form encrypted personal data in order to be able to provide the encrypted data to a data board unit. The encrypted personal data are received by the data board unit in a step 211 and conveyed to the end unit in a step 213 chronologically immediately subsequently or at a later point in time.

According to one exemplary embodiment, the encrypted personal data, once received by the end unit, are decrypted by the end unit in a step 215. For this purpose, the end unit uses the shares of the decryption key provided by the group of monitoring units.

According to one exemplary embodiment, the end unit outputs a payment instruction to a transaction unit in a step 217. The transaction unit receives the payment instruction in a step 219. Steps 217, 219 may be carried out at appropriate points in time of the method, for example, also after the implementation of step 211.

If an exemplary embodiment includes an “and/or” linkage between a first feature and a second feature, this is to be read in the sense that the exemplary embodiment according to one specific embodiment includes both the first feature and the second feature, and according to another specific embodiment, either only the first feature or only the second feature.

1-10. (canceled)

11. A method for transmitting personal data, the method comprising the following steps:
receiving a request of a sensor unit represented by an electrical signal for detecting personal data via a sensor interface of a group of monitoring units to the sensor unit;
generating an encryption key and shares of a decryption key using the group of monitoring units in response to the receipt of the request, the decryption key being divided into the shares using a method for secret sharing and each of the group of monitoring units being assigned one of the shares;
providing the encryption key to the sensor unit via the sensor interface; and
providing the shares of the decryption key to an end unit via an end interface of the group of monitoring units to the end unit.

12. The method as recited in claim 11, further comprising the following step:
blocking the provision of the shares of the decryption key to the end unit if the personal data has already been sold to another end unit.

13. The method as recited in claim 11, further comprising the following step:
generating encrypted personal data via the sensor unit using the personal data and the encryption key.

14. The method as recited in claim 13, further comprising the following steps:
receiving the encrypted personal data via an input interface of a data board unit to the sensor unit; and
providing the encrypted personal data via an output interface of the data board unit to the end unit.

15. The method as recited in claim 14, further comprising the following step:
decrypting the encrypted personal data via use by the end unit of the shares of the decryption key.

16. The method as recited in claim 11, further comprising the following step:
outputting a payment instruction via the end unit.

17. The method as recited in claim 16, further comprising the following step:
receiving the payment instruction via a transaction unit via an interface of the transaction unit to the end unit.

18. A device for transmitting personal data, the device configured to:
receive a request of a sensor unit represented by an electrical signal for detecting personal data via a sensor interface of a group of monitoring units to the sensor unit;
generate an encryption key and shares of a decryption key using the group of monitoring units in response to the receipt of the request, the decryption key being divided into the shares using a method for secret sharing and each of the group of monitoring units being assigned one of the shares;
provide the encryption key to the sensor unit via the sensor interface; and
provide the shares of the decryption key to an end unit via an end interface of the group of monitoring units to the end unit.

19. A non-transitory machine-readable memory medium on which is stored a computer program for transmitting personal data, the computer program, when executed by a computer, causing the computer to perform the following steps:
receiving a request of a sensor unit represented by an electrical signal for detecting personal data via a sensor interface of a group of monitoring units to the sensor unit;
generating an encryption key and shares of a decryption key using the group of monitoring units in response to the receipt of the request, the decryption key being divided into the shares using a method for secret sharing and each of the group of monitoring units being assigned one of the shares;
providing the encryption key to the sensor unit via the sensor interface; and
providing the shares of the decryption key to an end unit via an end interface of the group of monitoring units to the end unit.
